(19) United States
(12) Patent Application Publication
(10) Pub. No.: US 2020/0332741 A1
(43) Pub. Date: Oct. 22, 2020

(54) THRUST NOZZLE FOR A TURBOFAN ENGINE ON A SUPERSONIC AIRCRAFT

(71) Applicant: Rolls-Royce Deutschland Ltd & Co KG, Blankenfelde-Mahlow (DE)

(72) Inventors: Predrag TODOROVIC, Berlin (DE); Thomas SCHILLINGER, Berlin (DE); Sören STEINER, Rangsdorf (DE)

(21) Appl. No.: 16/954,094

(22) PCT Filed: Dec. 11, 2018
(86) PCT No.: PCT/EP2018/084319

§ 371 Date: Jun. 15, 2020

(30) Foreign Application Priority Data
Dec. 19, 2017 (DE) 10 2017 130 568.8

(51) Int. Cl. F02K 1/06; F02K 1/04

(52) U.S. Cl. CPC F02K 1/06; F02K 1/04; F05D 2250/324; B64D 2033/026; F05D 2260/606; F05D 2250/323; F05D 2220/80; F05D 2220/36

(57) ABSTRACT

The invention relates to a thrust nozzle for a turbofan engine of a supersonic aircraft, wherein the thrust nozzle includes a thrust nozzle wall, and a flow channel that is delimited radially outwards by the thrust nozzle wall, wherein the flow channel has a nozzle throat surface and a central body that is arranged in a flow channel. According to the invention, the central body forms a bypass channel, which extends within the central body, and which is designed for the gas of the flow channels to flow through. The bypass channel has at least one upstream inlet opening, which is arranged upstream of the nozzle throat surface of the flow channel, and at least one downstream outlet opening, which is arranged downstream of the nozzle throat surface of the flow channel

The invention relates to a thrust nozzle for a turbofan engine of a supersonic aircraft according to the preamble of patent claim 1.

It is known from military applications to form a convergent-divergent thrust nozzle of a turbofan engine with an adjustable geometry in order to be able to implement a large number of combinations with regard to the nozzle throat area (commonly referred to as A8) and the nozzle exit area (commonly referred to as A9). For this purpose, it is for example known to form a thrust nozzle as an iris/petal nozzle with a large number of individual adjustable lamellae. The complexity of such thrust nozzles is high because the individual lamellae have to be provided with actuators for the adjustability thereof. Further disadvantages are an increased weight of the thrust nozzle owing to the actuators, a high level of noise generation, and an intensive maintenance requirement.

It is known from the Messerschmidt 262 fighter aircraft to arrange a central body in a thrust nozzle, which central body is axially adjustable for the purposes of setting the nozzle exit area by means of a nozzle needle arranged on the machine axis.

The present invention is based on the object of providing a thrust nozzle, which is suitable for supersonic operation, of a turbofan engine, which thrust nozzle permits setting of the nozzle throat area in an efficient manner. It is furthermore sought to provide methods for setting the nozzle throat area.

Said object is achieved by means of a thrust nozzle having the features of patent claim 1, a method having the features of patent claim 17, and a method having the features of patent claim 19. Design embodiments of the invention are set forth in the dependent claims.

Accordingly, the present invention concerns a thrust nozzle for a turbofan engine of a supersonic aircraft, which thrust nozzle has a thrust nozzle wall, a flow channel which is delimited radially to the outside by the thrust nozzle wall, and a central body arranged in the flow channel. Here, the flow channel forms a nozzle throat area, which refers to the smallest cross-sectional area between the central body and the thrust nozzle wall.

The invention provides for the central body to form a bypass channel which extends within the central body and which is provided for being flowed through by gas of the flow channel. Here, the bypass channel has at least one upstream inlet opening, which is arranged upstream of the nozzle throat area of the flow channel, and at least one downstream outlet opening, which is arranged downstream of the nozzle throat area of the flow channel.

The solution according to the invention makes it possible, through the formation of a bypass channel in the central body, for the effective nozzle throat area of the flow channel to be set. Here, the effective nozzle throat area is made up of the nozzle throat area of the flow channel (that is to say the smallest cross-sectional area of the flow channel between central body and thrust nozzle wall) and the opening cross section of the bypass channel. The effective nozzle throat area can be varied through setting of the opening cross section of the bypass channel. Here, the opening cross section or flow cross section of the bypass channel may be set at any desired location in the bypass channel. This may for example be the opening cross section of the inlet opening or the opening cross section of the outlet opening of the bypass channel. Here, the possibility of setting the effective nozzle throat area exists without the need for the thrust nozzle wall or the central body to be provided with an adjustable geometry.

The bypass channel can be used for various purposes.

In a first variant of the invention, the possibility of varying the effective nozzle throat area through setting of the opening cross section of the bypass channel is utilized to compensate deviations, arising owing to manufacturing tolerances, of the nozzle throat area from a predefined value to be implemented. This possibility of compensation eliminates the need to produce the components which form the nozzle throat area with a small manufacturing tolerance. Since the manufacture of components with a small tolerance constitutes a significant cost factor, the invention permits considerable cost savings. The invention makes it possible to produce the components which form the nozzle throat area with relatively large tolerances, by virtue of the predefined effective nozzle throat area being retroactively set and optimized through corresponding setting of the opening cross section of the bypass channel.

The settability of the opening cross section of the bypass channel may also be utilized to easily compensate a change of the nozzle throat area over time, which is caused by the operation of the aircraft engine. It is thus possible for a changed nozzle throat area to be corrected through readjustment of the opening cross section of the bypass channel. In this way, the time between overhaul (TBO) can be increased, leading to further cost savings.

In a second invention variant, the possibility of varying the effective nozzle throat area through setting of the opening cross section of the bypass channel is utilized to continuously set the effective nozzle throat area during the operation of the engine in order to set the effective nozzle throat area in a desired manner in every operating state or at least in particular operating states. Through setting or changing of the effective nozzle throat area, it is possible here for the degree of expansion of the flow channel downstream of the nozzle throat area, that is to say the ratio of the aerodynamically effective areas A9′/A8′ (which is always greater than or equal to one), to be set for every operating state. An enlargement of the effective nozzle throat area through setting of a maximum opening cross section of the bypass channel leads here to an increase of the value A8′, such that the effective degree of expansion is reduced. By contrast, in the case of a closed bypass channel, the effective degree of expansion is increased.

In one advantageous embodiment, provision is made whereby, during the start process, the effective nozzle throat area is maximized, such that the risk of choking (of a flow at the speed of sound through the nozzle throat) of the thrust nozzle owing to an excessively high degree of expansion of the flow channel is reduced. In this way, the risk of intense noise generation that arises in the case of a choked thrust nozzle is also reduced.

The present invention is associated with the further advantage that the flow losses caused by the flow through the bypass channel are relatively low, because the inlet opening of the bypass channel is situated upstream of the nozzle throat area of the flow channel and thus at an axial position at which the gas flowing in the flow channel has not yet reached its highest speed, which it first reaches in the nozzle throat area in the case of a subcritical flow through the nozzle. It is advantageous here that tapping of the main mass flow through the thrust nozzle occurs at as low a Mach number as possible, such that associated disruption of the three-dimensional flow field is minor.

It is pointed out that the opening cross section of the bypass channel refers to the smallest cross-sectional area along the longitudinal extent of the bypass channel. This smallest cross-sectional area defines the degree of opening of the bypass channel, that is to say the mass flow that can flow through the bypass channel. The larger the opening cross section of the bypass channel, the greater the mass flow through the bypass channel and accordingly also the greater the influence on the effective nozzle throat area.

It is furthermore pointed out that the bypass channel does not necessarily extend exclusively in the central body. It is merely necessary for the bypass channel to also extend in the central body. As will be discussed further, provision may for example be made whereby an upstream portion of the bypass channel is formed in struts via which the central body is connected to the thrust nozzle wall.

It is furthermore pointed out that the thrust nozzle wall refers generally to the wall of the thrust nozzle. The thrust nozzle wall may be of multi-layer construction, and may in particular comprise an inner wall and an outer wall. Here, the inner wall faces toward the gas flow and delimits the flow path through the thrust nozzle. The outer wall adjoins the surroundings. Provision may furthermore be made whereby the thrust nozzle wall comprises both spatially fixed regions and movable regions, for example components of a thrust reversal means. The thrust nozzle wall may also be referred to as the peripheral housing of the thrust nozzle.

The at least one upstream inlet opening, formed by the central body, of the bypass channel may comprise one or more inlet openings. For example, in one design variant, a central inlet opening is formed in the central body. In another design variant, a large number of inlet openings is provided, which are formed in the upstream portion of the central body so as to be spaced apart in a circumferential direction. Correspondingly, the at least one downstream outlet opening may comprise one or more outlet openings.

The bypass channel extends at least partially in an axial direction in the central body. In one embodiment of the invention, the bypass channel extends at least partially along the longitudinal axis of the central body.

One embodiment of the invention provides for the central body to be connected via at least one strut to the thrust nozzle wall. This aspect of the invention is based on the concept of connecting the central body arranged in the flow channel to the thrust nozzle wall exclusively via one or more struts, and to thereby achieve that loads acting on the central body are introduced directly into the thrust nozzle wall. By contrast, a mounting of the central body at rear regions of the core engine, and an associated introduction of loads acting on the central body into the core engine and/or rotor bearing structures of the engine, are not provided in this design variant.

Here, provision may be made whereby the struts have a streamlined profile with a leading edge and a trailing edge. The profile is aerodynamically optimized in order to minimize the air resistance generated by the struts. Here, in one design variant, the profile is of symmetrical design and is not designed to generate lift.

The central body may basically be connected to the thrust nozzle wall via one or more struts, for example via two, three, four or five struts, which are arranged equidistantly with respect to one another in a circumferential direction. One embodiment of the invention provides for the central body to be connected via exactly two struts to the thrust nozzle wall, wherein the two struts are arranged approximately in a plane, that is to say are spaced apart in the circumferential direction by approximately 180°, wherein slightly angled arrangements of the two struts with respect to one another are also possible, for example with a spacing of the top sides in the circumferential direction in the range between 160° and 200°. A lightweight mounting of the central body on the thrust nozzle wall, which has only a minimal influence on the flow in the flow channel, is made possible through the use of two struts.

The struts may be of solid or lightweight construction, in particular may be substantially hollow or formed with defined cavities.

One design variant provides for at least one upstream inlet opening of the bypass channel to be formed in one of the struts. In particular, such an upstream inlet opening is formed in the region of the leading edge of the corresponding strut. Here, the bypass channel forms a first, upstream portion in at least one of the struts and a second, downstream portion in the central body. In this design variant, the bypass channel is thus formed not exclusively in the central body but both in the struts and in the central body. For example, the bypass channel has, at its upstream end, two arms which each begin at the leading edge of a strut and form in each case one inlet opening there, wherein the two arms converge in an axial direction and merge in or upstream of the central body.

It is pointed out that the connection of the central body to the thrust nozzle wall via at least one strut constitutes only one exemplary embodiment of the invention. Alternatively, provision may for example be made whereby the central body is arranged in the flow channel, and fixed there, via a nozzle needle arranged on the machine axis.

As already stated, the opening cross section of the bypass channel is settable. Such settability may, in a simple embodiment of the invention, be provided by virtue of exchangeable trim inserts with a defined cross-sectional area being inserted into the bypass channel at the start or at the end thereof. Such setting of the opening cross section of the bypass channel is performed for example on a test stand.

A further embodiment of the invention provides for the opening cross section of the bypass channel to be settable in continuous fashion by means of at least one actuator by means of which a cross-sectional area of the bypass channel is settable. The continuous settability of the opening cross section of the bypass channel permits setting of the effective nozzle throat area during flight, and at the same time a continuous adaptation of the effective nozzle throat area to the present operating state.

The settable cross-sectional area is for example the cross-sectional area of the inlet opening of the bypass channel (or the cross-sectional area of at least one inlet opening of the bypass channel, if the bypass channel has multiple inlet openings). Here, when not set to a maximum, the settable cross-sectional area constitutes the smallest cross-sectional area in the bypass channel, such that the mass flow through the bypass channel is set by means of the settable cross-sectional area. In another exemplary embodiment, the settable cross-sectional area is the cross-sectional area of the outlet opening of the bypass channel (or the cross-sectional area of at least one outlet opening of the bypass channel, if the bypass channel has multiple outlet openings). It is however pointed out that the settable cross-sectional area need not imperatively be implemented at the inlet opening or at the outlet opening, but may alternatively also be formed at an axial position between the inlet opening and the outlet opening of the bypass channel.

An inlet opening which is settable with regard to its cross-sectional area and/or an outlet opening which is settable with regard to its cross-sectional area is formed for example by valve flaps, iris apertures, openings provided with adjustable lamellae, axially displaceable central bodies or the like.

Accordingly, one embodiment of the invention provides for the opening cross section of the bypass channel to be settable by means of a closure body which is movable in an axial direction in the bypass channel and the axial position of which defines the opening cross section of the bypass channel. Here, provision may be made whereby the closure body which is movable in the axial direction is displaceable in the axial direction relative to an upstream inlet opening or relative to a downstream outlet opening of the central body, wherein the closure body has for example a droplet shape.

In one embodiment of the invention, the at least one actuator by means of which a cross-sectional area of the bypass channel is settable is arranged in or radially outside the thrust nozzle wall, which delimits the flow channel radially to the outside. The actuator is thus situated in the “cold structure” of the thrust nozzle, that is to say is not exposed to the hot gases in the flow channel. In this way, wear of the actuator is minimized, and the actuator can be of less expensive design.

The thrust nozzle according to the invention basically does not need an adjustable geometry, that is to say the nozzle throat area and the nozzle exit area are not variable in terms of their geometry. As already discussed, the nozzle throat area refers to the narrowest or smallest cross-sectional area of the flow channel between central body and thrust nozzle wall. The nozzle exit area refers to the cross-sectional area of the flow channel at the rear end of the thrust nozzle. Thus, in one exemplary embodiment of the invention, the thrust nozzle wall is not settable in terms of its geometry.

The central body may basically be shaped in a variety of ways. Embodiments provide for the central body to have an upstream end and a downstream end and to form at least one maximum of its cross-sectional area between these. From the upstream end, the cross-sectional area increases in an axial direction proceeding from zero, or from a starting value greater than zero, up to the at least one maximum. Toward the downstream end, the cross-sectional area decreases to zero, or to a final value greater than zero. Here, provision may be made whereby the central body is of conical shape at the upstream end and/or at the downstream end. In a preferred variant, the central body is arranged in the flow channel exclusively via struts.

In a preferred variant of the invention, the central body is spatially fixed in an axial direction. In this way, a simple and inexpensive solution is provided. Settability of the effective nozzle throat area is in this case made possible by means of the bypass channel.

Alternatively, provision may be made whereby the central body is arranged so as to be displaceable in an axial direction. By means of axial displaceability of the central body, a thrust nozzle is provided which has a flow channel which forms a variable nozzle throat area and a variable nozzle exit area, wherein the present values of the nozzle throat area and of the nozzle exit area are dependent on the axial position of the central body. The settability of nozzle throat area and nozzle exit area constitutes an additional possibility (in addition to the settability of the opening cross section of the bypass channel) for setting the degree of expansion of the flow channel downstream of the nozzle throat area, that is to say the ratio A9/A8.

To realize axial displaceability of the central body, one embodiment of the invention provides for the central body to be axially displaceable relative to the struts. For this purpose, for example, a rail guide and actuators are provided, by means of which the central body is displaceable in the axial direction relative to the radially inner ends of the struts. An alternative embodiment provides, for the axial displaceability of the central body, that the struts are axially displaceable relative to the thrust nozzle wall. Here, displaceability of the central body relative to the struts is not necessary. To realize displaceability of the struts relative to the thrust nozzle wall, it is in turn the case, for example, that a rail guide and actuators are provided, by means of which the radially outer ends of the struts are displaceable in an axial direction relative to the thrust nozzle wall. For example, hydraulic pistons or electric motors serve as actuators.

In the case of both embodiments, provision may be made whereby the actuators which effect axial displaceability of the central body are arranged in the thrust nozzle wall (for example on that side of an inner nozzle wall which is averted from the flow channel) and thus in the “cold structure” (outside the hot gases of the flow channel). Here, provision may be made whereby the adjusting force, or the torque which is transmitted for an adjustment, is transmitted by means of a linkage connected by means of joints, or the like, to the interface between central body and struts or to the interface between struts and thrust nozzle wall, where the transmitted force or the transmitted torque is converted into a translational movement. If the central body is displaceable relative to the struts, provision is made whereby such a linkage is led to the interface between the central body and the struts through cavities which are formed in the struts.

A further embodiment of the invention provides for the thrust nozzle to be designed as a convergent thrust nozzle, as a convergent-diverging thrust nozzle, or as a convergent-cylindrical thrust nozzle. Accordingly, in the two latter cases, the thrust nozzle wall is designed so as to have a narrowest cross section and an exit cross section which is larger than or identical to said narrowest cross section. The design of the thrust nozzle as a convergent-diverging thrust nozzle or as a convergent-cylindrical thrust nozzle is however not imperative. For example, the thrust nozzle may alternatively be designed as a thrust nozzle in the case of which the nozzle throat area and the nozzle exit area of the thrust nozzle wall coincide.

The thrust nozzle according to the invention is, in one exemplary embodiment, an integral thrust nozzle, wherein the primary flow through the core engine and the secondary flow through the bypass channel are mixed before being conducted into the integral thrust nozzle. Alternatively, the thrust nozzle according to the invention may be a separate thrust nozzle for the primary flow channel.

In other aspects of the invention, the invention relates to a turbofan engine for a civilian or military supersonic aircraft, having a thrust nozzle according to the invention. The turbofan engine may have a thrust reverser.

In a further aspect of the invention, the invention relates to a method for setting the effective nozzle throat area of a thrust nozzle on a test stand, characterized by:
operating a turbofan engine having a thrust nozzle according to the invention on a test stand;
setting that opening cross section of the bypass channel in the case of which the effective nozzle throat area arising from the sum of the opening cross section of the bypass channel and of the nozzle throat area corresponds to a desired value; and
fixing the set opening cross section of the bypass channel.

This method permits the exact setting of a predefined value for the effective nozzle throat area in a simple manner, even in the case of components which delimit the flow channel having manufacturing tolerances.

The fixing of the set opening cross section of the bypass channel may be realized for example by means of at least one trim insert with a defined cross-sectional area, which is inserted into the bypass channel at the start or at the end thereof. Here, multiple trim inserts with different opening cross section may be stocked.

In a further aspect of the invention, the invention relates to a method for setting the effective nozzle throat area of a thrust nozzle according to the invention of a turbofan engine during the operation thereof. The method is characterized by:
varying the opening cross section of the bypass channel in a manner dependent on the operating point of the engine, such that
the effective nozzle throat area arising from the sum of the opening cross section of the bypass channel and of the nozzle throat area of the flow channel corresponds to a desired value in every operating state.

This method utilizes continuous settability of the opening cross section of the bypass channel in order to optimally set the effective nozzle throat area in a manner dependent on the operating point of the engine. A preferred variant in this regard provides for the opening cross section of the bypass channel to be set to a maximum upon starting, in order to minimize the risk of “choking” the thrust nozzle upon starting.

It is pointed out that the present invention is described with reference to a cylindrical coordinate system which has the coordinates x, r, and φ. Here, x indicates the axial direction, r indicates the radial direction, and φ indicates the angle in the circumferential direction. The axial direction is in this case identical to the machine axis of the turbofan engine and is also identical to the longitudinal axis of the central body. Proceeding from the x-axis, the radial direction points radially outward. Terms such as “in front of”, “behind”, “front”, and “rear” always relate to the axial direction, or the flow direction in the engine. The expression “in front of” thus means “upstream of”, and the expression “behind” means “downstream of”. Terms such as “outer” or “inner” always relate to the radial direction.

The invention will be explained in more detail below on the basis of a plurality of exemplary embodiments with reference to the figures of the drawing. In the drawing:

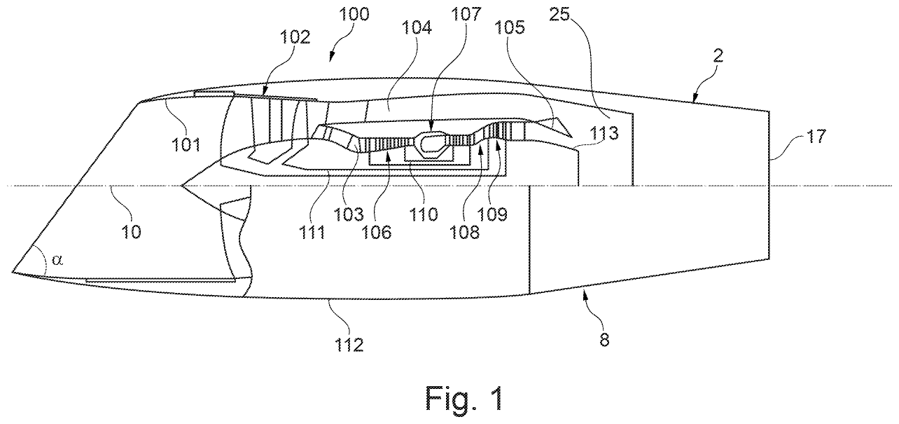

FIG. 1 is a simplified schematic sectional illustration of a turbofan engine in which the present invention can be realized, wherein the turbofan engine is suitable for use in a civilian or military supersonic aircraft;

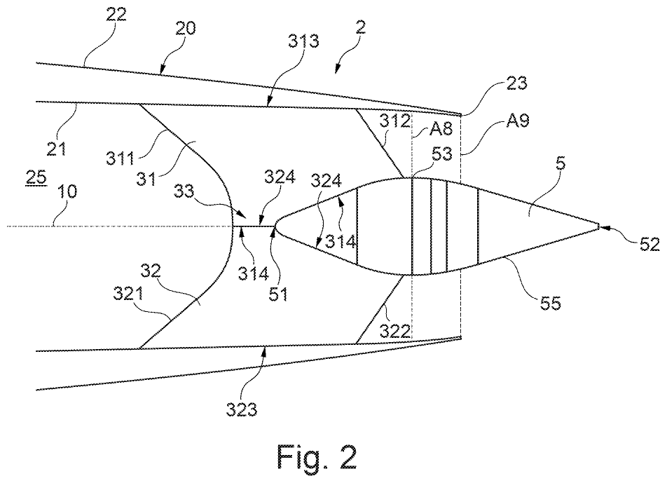

FIG. 2 shows, in a sectional view, an exemplary embodiment of a thrust nozzle with a central body which is connected via two struts to the thrust nozzle wall of the thrust nozzle;

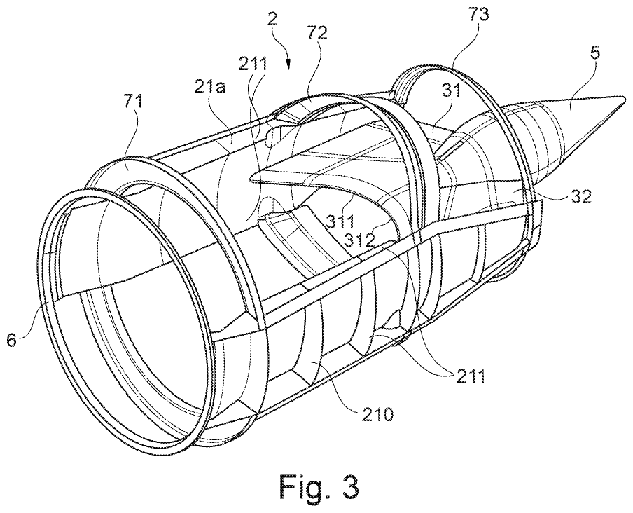

FIG. 3 shows the thrust nozzle of FIG. 2 in a perspective view obliquely from the front;

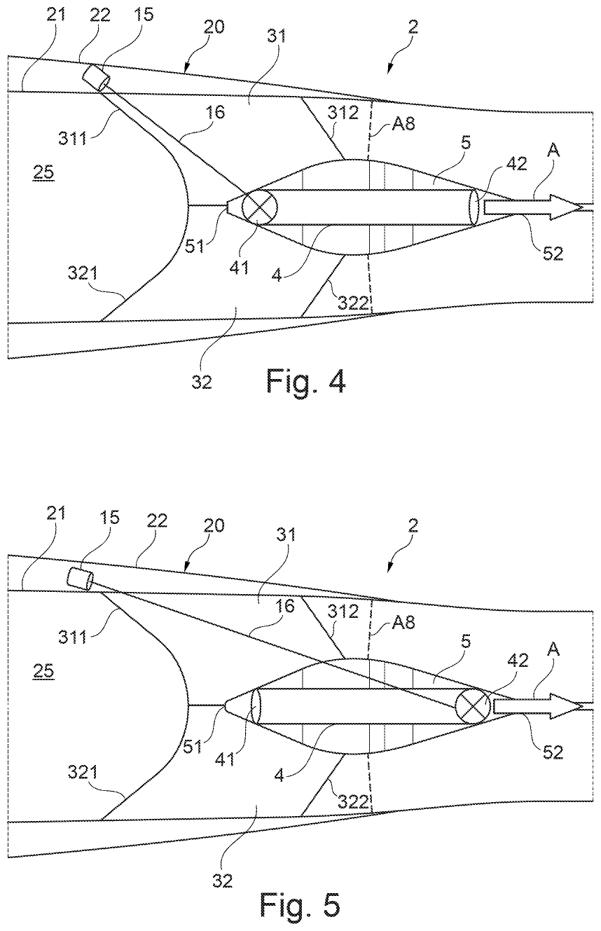

FIG. 4 shows a first exemplary embodiment of a thrust nozzle with a central body which forms a bypass channel, wherein the cross-sectional area of the inlet opening of the bypass channel is settable;

FIG. 5 shows a second exemplary embodiment of a thrust nozzle with a central body which forms a bypass channel, wherein the cross-sectional area of the outlet opening of the bypass channel is settable;

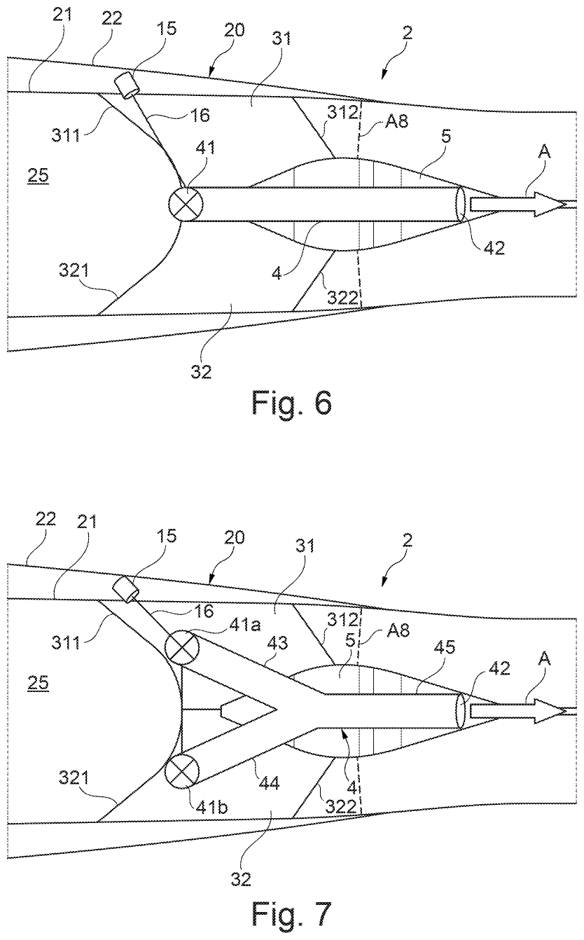

FIG. 6 shows a third exemplary embodiment of a thrust nozzle with a central body which forms a bypass channel, wherein the cross-sectional area of the inlet opening of the bypass channel is settable, and the inlet opening is formed at the leading edge by struts which connect the central body to the thrust nozzle wall;

FIG. 7 shows a fourth exemplary embodiment of a thrust nozzle with a central body which forms a bypass channel, wherein the bypass channel is formed partially in struts which connect the central body to the thrust nozzle wall, and wherein, in the struts, there is formed in each case one inlet opening, which is settable in terms of its cross-sectional area, of the bypass channel;

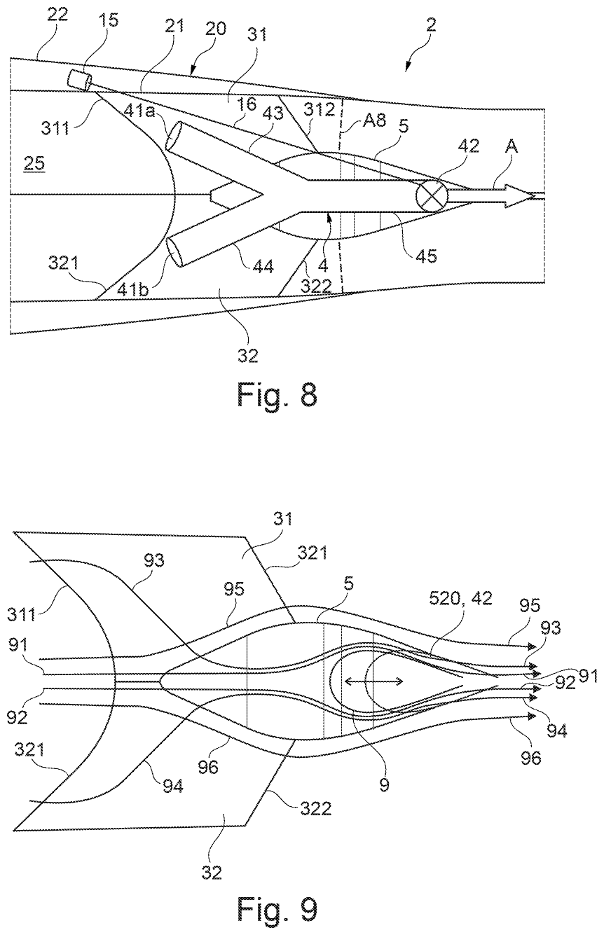

FIG. 8 shows a fifth exemplary embodiment of a thrust nozzle with a central body which forms a bypass channel, wherein the bypass channel is formed partially in struts which connect the central body to the thrust nozzle wall, and wherein the cross-sectional area of the outlet opening, formed in the central body, of the bypass channel is settable;

FIG. 9 shows a sixth exemplary embodiment of a thrust nozzle with a central body which forms a bypass channel, wherein the opening cross section of the bypass channel is settable by means of a droplet-shaped closure body which is movable in an axial direction relative to a downstream outlet opening of the central body;

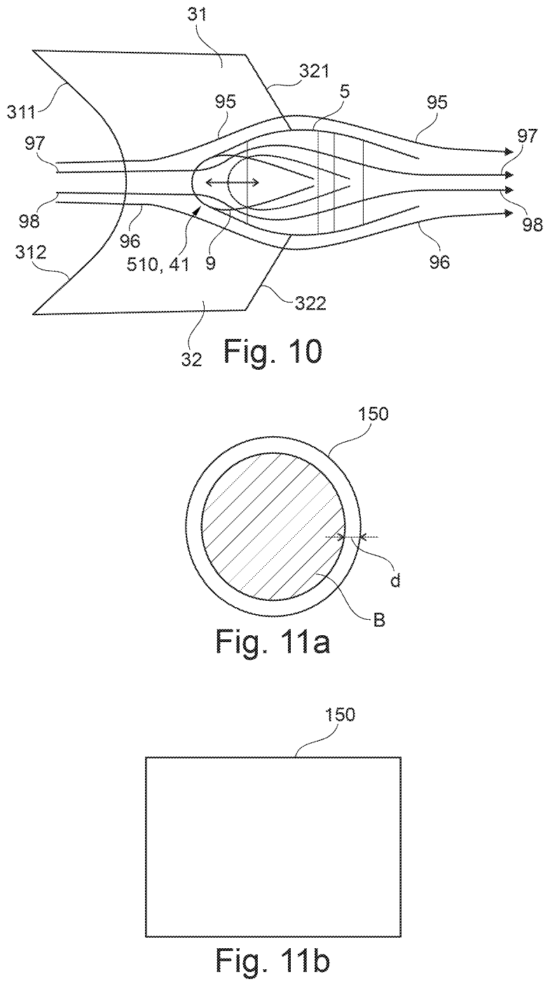

FIG. 10 shows a seventh exemplary embodiment of a thrust nozzle with a central body which forms a bypass channel, wherein the opening cross section of the bypass channel is settable by means of a droplet-shaped closure body which is movable in an axial direction relative to an upstream inlet opening of the central body;

FIG. 11a shows a trim insert in a view from the front; and

FIG. 11b shows the trim insert of FIG. 11a in a side view.

FIG. 1 shows a turbofan engine which is provided and suitable for being used in a civilian or military supersonic aircraft and which is accordingly designed for operating states in the subsonic range, in the transonic range and in the supersonic range.

The turbofan engine 100 comprises an engine intake 101, a fan 102, which may be of multi-stage design, a primary flow channel 103, which leads through a core engine, a secondary flow channel 104, which leads past the core engine, a mixer 105 and a convergent-divergent thrust nozzle 2, into which a thrust reverser 8 may be integrated.

The turbofan engine 100 has a machine axis or engine centerline 10. The machine axis 10 defines an axial direction of the turbofan engine. A radial direction of the turbofan engine runs perpendicular to the axial direction.

The core engine has, in a manner known per se, a compressor 106, a combustion chamber 107 and a turbine 108, 109. In the exemplary embodiment illustrated, the compressor comprises a high-pressure compressor 106. A low-pressure compressor is formed by those regions of the multi-stage fan 102 which are close to the hub. The turbine, which is arranged downstream of the combustion chamber 107, comprises a high-pressure turbine 108 and a low-pressure turbine 109. The high-pressure turbine 108 drives a high-pressure shaft 110 which connects the high-pressure turbine 108 to the high-pressure compressor 106. The low-pressure turbine 109 drives a low-pressure shaft 111, which connects the low-pressure turbine 109 to the multi-stage fan 102. In an alternative embodiment, the turbofan engine may additionally have a medium-pressure compressor, a medium-pressure turbine and a medium-pressure shaft. Furthermore, in an alternative embodiment, provision may be made whereby the fan 102 is coupled via a speed-reducing transmission, for example a planetary transmission, to the low-pressure shaft 111.

The turbofan engine is arranged in an engine nacelle 112. This is for example connected via a pylon to the aircraft fuselage.

The engine intake 101 forms a supersonic air intake and is accordingly provided and suitable for decelerating the inflowing air to speeds below Ma 1.0 (Ma=Mach number). The engine intake is, in FIG. 1, but not imperatively, sloped so as to form an angle α, wherein the lower edge protrudes relative to the upper edge. This serves for better distributing compression shocks, which arise during supersonic flight, in an upward direction. It is however basically also possible for the engine intake to be of straight form, that is to say formed with an angle α of 90°, or formed with some other angle.

The flow channel through the fan 102 is divided, downstream of the fan 102, into the primary flow channel 103 and the secondary flow channel 104. The secondary flow channel 104 is also referred to as secondary flow channel or bypass channel.

Downstream of the core engine, the primary flow in the primary flow channel 103 and the secondary flow in the secondary flow channel 104 are mixed by the mixer 105. Furthermore, downstream of the turbine, there is attached an exit cone 113 for realizing desired cross sections of the flow channel.

The rear region of the turbofan engine is formed by an integral thrust nozzle 2, wherein the primary flow and the secondary flow are mixed in the mixer 105 before being conducted into the integral thrust nozzle 2. Here, downstream of the mixer 105, the engine forms a flow channel 25 which extends through the thrust nozzle 2. Alternatively, separate thrust nozzles may be provided for the primary flow channel 103 and the secondary flow channel 104.

In the context of the present invention, it is the configuration of the thrust nozzle 2, illustrated merely schematically in FIG. 1, which is of importance. Before the present invention is discussed on the basis of FIGS. 4-10, the basic construction of a thrust nozzle 2 in which the invention according to a design variant is realized will be described on the basis of FIGS. 2 and 3 for the purposes of improved understanding of the invention.

FIG. 2 shows a convergent-divergent thrust nozzle 2 in a longitudinal section encompassing the machine axis 10. The thrust nozzle 2 comprises a thrust nozzle wall 20 which is formed by an inner wall 21 and an outer wall 22. Here, the inner wall 21 forms, at the inner side, the radially outer boundary of the flow channel 25 in the thrust nozzle 2. The outer wall 22 is formed radially at the outside in relation to the inner wall 21 and adjoins the surroundings. The inner wall 21 and the outer wall 22 taper to a point in a downstream direction and, at their downstream end, form a nozzle exit edge 23.

The thrust nozzle 2 furthermore comprises a central body 5 which is formed as a body of revolution and which forms a surface 55. The central body 5 has a longitudinal axis which is identical to the machine axis 10. The central body 5 forms an upstream end 51, a downstream end 52 and, between the upstream end 51 and the downstream end 52, a maximum 53 of its cross-sectional area. Here, it is provided in the illustrated exemplary embodiment, but not imperatively, that the central body 5 is of conical form adjacent to its upstream end 51 and in the direction of its downstream end 52. Provision is made whereby the central body 5 forms a bypass channel, which is not illustrated in FIGS. 2 and 3 but which will be discussed in more detail on the basis of FIGS. 4-10.

The upstream end 51 of the central body 5 may be formed by a point (as illustrated) or by a surface. Likewise, the downstream end 52 may be formed by a point or a surface (as illustrated).

The thrust nozzle 2 forms a nozzle throat area A8, at which the cross-sectional area between the central body 5 and the inner wall 21 is at a minimum. Typically, the axial position of the nozzle throat area A8 is defined by the axial position of the maximum 53 of the central body 5. However, this is not necessarily the case. At the nozzle exit edge 23, the thrust nozzle forms a nozzle outlet area A9. This is equal to the difference between the cross-sectional area that the inner wall 21 forms at the nozzle exit edge 23 and the cross-sectional area of the central body 5 in the plane in question. The ratio A9 to A8 defines the degree of expansion of the flow channel 25 downstream of the nozzle throat area A8.

The thrust nozzle 2 furthermore comprises two struts 31, 32 which connect the central body 5 to the thrust nozzle wall 20, specifically the inner wall 21, and which for this purpose extend from the central body 5 in the radial direction through the flow channel 25 to the thrust nozzle wall 20. The struts 31, 32 each have a streamlined, symmetrical profile with a leading edge 311, 321 and a trailing edge 312, 322, and with an upper side and a lower side (which cannot be illustrated in the sectional illustration of FIG. 2). Each strut 31, 32 furthermore has a radially outer end 313, 323, at which it is connected to the inner wall 21, and a radially inner end 314, 324, at which it is connected to the central body 5. Here, the radially outer end 313, 323 forms an interface to the inner wall 21, and the radially inner end 314, 324 forms an interface to the central body 5.

Here, it is the case in the exemplary embodiment illustrated, but not imperatively, that the struts 31, 32 directly adjoin one another at their radially inner ends 314, 324 at their leading edges 311, 321 and in an upstream region 33 adjoining the leading edges 311, 321. Accordingly, they form a common, continuous leading edge which is not interrupted by the central body 5. Here, in the exemplary embodiment illustrated, the common leading edge 311, 321 forms an arcuate curve which extends furthest upstream at its radially outer ends adjoining the thrust nozzle wall 21 and extends furthest downstream at the centerline 10 of the thrust nozzle 2, wherein said common leading edge intersects the centerline 10 perpendicularly.

In other exemplary embodiments, the central body 5 adjoins as far as the leading edges 31, 32, or protrudes axially in relation thereto.

Owing to the formation of a region 33 in which the radially inner ends 314, 324 of the struts 31, 32 adjoin one another, the upstream end 51 of the central body 5 is situated downstream of the leading edge 311, 321 of the struts 31, 32. It is however pointed out that the upstream end 51 of the central body 5 is situated upstream of the nozzle throat area A8. The downstream end 52 of the central body 5 is situated downstream of the nozzle throat area A8 and also downstream of the nozzle exit area A9. The axial position at which the central body 5 forms the maximum 53 of its cross-sectional area lies downstream of the trailing edges 312, 323 of the struts 31, 32, wherein this is not imperatively the case.

The struts 31, 32 are arranged approximately in a plane which encompasses the machine axis 10. Here, an arrangement of the struts “approximately” in a plane is present insofar as the struts have a three-dimensional extent corresponding to the profile that they form. Furthermore, provision may basically also be made whereby the two struts 31, 32 are arranged at an angle with respect to one another.

In the exemplary embodiment of FIG. 2, the central body 5 is fixed relative to the struts 31, 32, and the struts 31, 32 are fixed relative to the inner wall 21, such that the central body 5 is not axially displaceable in the flow channel 25. By contrast, in other exemplary embodiments, such displaceability is realized.

FIG. 3 shows a perspective illustration of a thrust nozzle 2 designed correspondingly to FIG. 2. Here, the outer wall 22 of FIG. 2 is not illustrated, and the inner wall, which delimits the flow channel radially to the outside, is only partially illustrated. The inner wall comprises structurally reinforced side structures 21a, which are reinforced for example by means of struts 210. The reinforced side structures 21a comprise bearing points 211 for thrust reverser doors, which are illustrated in FIGS. 4 and 5. The side structures 21 are connected to one another at the top and at the bottom by means of semicircular structural elements 71, 72, 73. Here, the structural elements 71, 72, 73 also form a structure for the fastening of the outer wall 22 illustrated in FIG. 2.

As described with regard to FIG. 2, the thrust nozzle 2 comprises a central body 5 which is fixedly connected to the inner wall 21 by means of two streamlined struts 31, 32.

The thrust nozzle 2 furthermore has an upstream coupling region for a connection of the thrust nozzle 2 to housing components of the core engine, for example for the connection to a turbine housing. Said coupling region forms an interface for the fastening of the thrust nozzle 2, and in the exemplary embodiment illustrated is formed by a ring-shaped flange 6. Here, loads acting on the central body 5 are conducted via the struts 31, 32 and the reinforced side structures 21a to the ring-shaped flange 6, via which said loads can be dissipated into housing components connected to the flange 6.

The central body 5 forms a bypass channel. A first exemplary embodiment in this regard is illustrated in FIG. 4. The construction of the thrust nozzle 2 corresponds, aside from the configuration of the central body 5 with a bypass channel, to the construction of FIGS. 2 and 3. As per FIG. 4, a bypass channel 4 extends in the axial direction in the central body 5, which bypass channel comprises an upstream inlet opening 41 and a downstream outlet opening 42. The bypass channel 4 is merely schematically illustrated. Said bypass channel runs for example with a constant diameter along the longitudinal axis of the central body 5. It is however pointed out that the bypass channel 4 may basically be of any desired shape. For example, it is alternatively possible for the central body 5 as a whole to be of hollow form, wherein the hollow interior of the central body 5 serves in its entirety as a bypass channel 4.

The inlet opening 41 of the bypass channel 4 is formed at the upstream end 51 of the central body 5. The outlet opening 42 of the bypass channel 4 is formed at the downstream end 52 of the central body 5. It is also the case that the inlet opening 41 is arranged upstream of the nozzle throat area A8 of the flow channel 25 and the outlet opening 42 is arranged downstream of the nozzle throat area A8 of the flow channel 25.

It is pointed out that the inlet opening 41 and the outlet opening 42 are merely schematically illustrated in FIG. 4 and also in the further figures. The inlet opening may be composed of exactly one inlet opening or of a multiplicity of inlet openings. In the latter case, provision may for example be made whereby a multiplicity of inlet openings are formed on the upstream portion of the central body 5 so as to be spaced apart in a circumferential direction. The inlet openings may for example be formed by valve flaps which open toward the central body 5. Likewise, the outlet opening may be composed of exactly one outlet opening or of a multiplicity of outlet openings.

The cross-sectional area of the inlet opening 41 of the bypass channel 4 is settable in continuous fashion by means of an actuator 15. The actuator 15 is for example an electric motor or a pneumatically operated piston which is coupled to the inlet opening 41 by means of an operative connection 16, for example a linkage 16 equipped with joints. Here, the operative connection 16 is led in corresponding cavities or channels in the strut 31. The actuator 15 is arranged on the outer side of the inner wall 21 of the thrust nozzle wall 20 and thus in the “cold structure” of the thrust nozzle 2. This is associated with the advantage that the actuator 15 is not exposed to the hot gases in the flow channel.

The adjustable inlet opening 41 may be formed in a variety of ways. For example, it is formed by an iris aperture, an opening with adjustable lamellae, or by a closure body which is axially displaceable in the inlet opening 41. With regard to the latter case, FIG. 10 shows an exemplary embodiment which will be discussed in more detail.

The degree of opening or the maximum mass flow A through the bypass channel 4 is set by means of the cross-sectional area of the inlet opening 41. By virtue of the inlet opening 41 being opened to a maximum extent, the effective nozzle throat area can be enlarged, whereby the degree of expansion of the thrust nozzle 2 is reduced. In the case of the inlet opening 41 being closed, the effective nozzle throat area is determined exclusively by the smallest cross-sectional area A8 in the flow channel between the central body 5 and the inner wall 21. The effective nozzle throat area is accordingly smaller, whereby the degree of expansion of the thrust nozzle 2 is increased.

For the setting of the mass flow through the bypass channel 4, it is sufficient to be able to set a cross-sectional area of the bypass channel. In this respect, the manner in which the bypass channel 4 is otherwise specifically formed is not of importance. In the exemplary embodiment of FIG. 4, as a cross-sectional area, the cross-sectional area of the inlet opening 41 is set.

FIG. 5 shows an exemplary embodiment in which the cross-sectional area of the outlet opening 42 of the bypass channel 4 is settable. The setting is performed by means of an actuator 15 and an operative connection 16.

In further exemplary embodiments, provision may be made whereby actuators for the setting of the cross-sectional area are provided both at the inlet opening 41 and at the outlet opening 42. It is basically not of importance where in the flow path of the bypass channel 4 the cross-sectional area is set. The setting may also be performed by means of a combination of settable portions at the inlet opening 41 and at the outlet opening 42.

FIG. 6 shows an exemplary embodiment which corresponds to the exemplary embodiment of FIG. 4 aside from the fact that the inlet opening 41 which is settable in terms of its cross-sectional area is formed at the leading edge 311, 312 of the struts 31, 32. For this purpose, provision may be made whereby the central body 5 is extended as far as the leading edge 311, 312. A setting of the cross-sectional area is in turn performed by means of an actuator 15 and an operative connection 16.

FIGS. 4-6 concern exemplary embodiments in which the bypass channel 4 is formed exclusively in the central body 5. However, this is not necessarily the case. FIG. 7 shows an exemplary embodiment in which the bypass channel 4 comprises upstream portions 43, 44 which are formed in the struts 31, 32. Accordingly, in this exemplary embodiment, the bypass channel 4 has two inlet openings 41a, 41b which are formed, spaced apart from the centerline, at the respective leading edge 311, 312 of the two struts 31, 32. From these inlet openings 41a, 41b, the two upstream portions 43, 44 run obliquely in the direction of the central body 5 and merge there to form a downstream portion 45, which ends at the outlet opening 42.

The mass flow A is defined by the two inlet openings 41a, 41b or by the cross-sectional area that these collectively form. The cross-sectional area of the inlet openings 41a, 41b is set by means of an actuator 15 and operative connections 16.

The exemplary embodiment of FIG. 7 is associated with the advantage that the air flowing into the bypass channel 4 originates from regions of the flow channel 25 which are situated closer to the edge of the flow channel 25. Air flowing into the central body 5 via the bypass channel 4 is thus relatively cool, and can be utilized for internally cooling the central body 5.

FIG. 8 shows an exemplary embodiment which corresponds to the exemplary embodiment of FIG. 7 aside from the fact that setting of the cross-sectional area is performed not at the inlet openings 41a, 41b but at the outlet opening 42. In this exemplary embodiment, too, the bypass channel 4 is formed partially in the struts 31, 32 and partially in the central body 5. A setting of the cross-sectional area of the outlet opening 42 is performed by means of an actuator 5 and an operative connection 16.

FIG. 9 shows more specifically a possible exemplary embodiment for the variation or setting of the cross-sectional area of an outlet opening 42 of the bypass channel 4. FIG. 9 shows the central body 5 and the struts 31, 32. The thrust nozzle wall is not illustrated. Furthermore, the course of the bypass channel 4 in the central body 5 is not illustrated in detail in FIG. 9. It is relevant that the central body 5 ends at an exit area 520 at which the end of the central body 5 is, in effect, truncated. This exit area 520 simultaneously forms the cross-sectional area of the outlet opening 42 of the bypass channel 4.

A closure body 9 of droplet-shaped form is arranged so as to be axially displaceable relative to said exit area 520. Depending on the axial position of the closure body 9, the exit area 520 and thus the cross-sectional area of the outlet opening 42 is closed to a greater or lesser extent, wherein complete closure is also possible. Such settability of the cross-sectional area of the exit opening 42 of the bypass channel 4 may for example be implemented in the exemplary embodiments of FIGS. 5 and 8. Here, the flow paths 91, 92 show, by way of example, the course of the flow in the exemplary embodiment of FIG. 5. The flow paths 93, 94 show, by way of example, the course of the flow in the exemplary embodiment of FIG. 7, in which two inlet openings 41a, 41b are provided. The flow paths 95, 96 illustrate, by way of example, flows which are conducted around the central body 5.

FIG. 10 shows, like FIG. 9, an exemplary embodiment in which the cross-sectional area is settable by means of a closure body 9 which is axially movable in the central body 5. By contrast to the situation in FIG. 9, however, the closure body 9 is in this case arranged in the region of the inlet opening 41 of the central body 5. As in the case of FIG. 9, the course of the bypass channel in the central body 5 is not illustrated in detail. It is relevant that the central body begins at an inlet area 510. This inlet area 510 simultaneously forms the cross-sectional area of the inlet opening 41 of the bypass channel 4. The closure body 9 of droplet-shaped form is arranged so as to be axially displaceable relative to said inlet area 510. Depending on the axial position of the closure body 9, the inlet area 510 and thus the cross-sectional area of the inlet opening 41 is closed to a greater or lesser extent, wherein complete closure is also possible. Such settability of the cross-sectional area of the exit opening 42 of the bypass channel 4 may for example be implemented in the exemplary embodiment of FIG. 4. The flow paths 97, 98 show, by way of example, the course of the flow in the exemplary embodiment of FIG. 4. The flow paths 95, 96 illustrate, by way of example, flows which are conducted around the central body 5.

The formation of a bypass channel 4 in the central body 5 may, according to a first variant, be utilized to compensate deviations, arising owing to manufacturing tolerances, of the nozzle throat area from a predefined value that is to be implemented, and a change of the nozzle throat area over time, which is caused by the operation of the aircraft engine. This may for example be performed on a test stand. Here, it is not necessary for the opening cross section of the bypass channel 4 to be settable in continuous fashion, as illustrated in FIGS. 4-10. Desired fixing of the cross-sectional area which is valid for a relatively long period of time may be realized for example by means of exchangeable trim inserts which are insertable into the inlet opening or into the outlet opening of the bypass channel, wherein trim inserts with different cross-sectional areas for the air passage are stocked.

FIGS. 11a, 11b show, by way of example, a trim insert 150 of said type in a view from the front and in a side view. The trim insert has a wall thickness d and a cross-sectional area B. Multiple trim inserts with different wall thicknesses d and accordingly different cross-sectional areas B are stocked. The trim insert 150 is inserted into an inlet opening 41 or an outlet opening 42 of the bypass channel 4 and fixed there. In this way, the cross-sectional area of the inlet opening 41 or of the outlet opening 42 is reduced to the cross-sectional area B. Depending on the trim insert used, it is possible to set a smaller or greater reduction of the cross-sectional area and thus a corresponding setting of the effective nozzle throat area.

According to a second variant, the formation of a bypass channel 4 in the central body 5 can be utilized to set the effective nozzle throat area during the operation of the engine in order to set the effective nozzle throat area in a desired manner in every operating state. Here, the degree of expansion of the flow channel can be set through setting or changing of the effective nozzle throat area.

The present invention is not restricted in terms of its configuration to the exemplary embodiments described above. For example, it is to be understood merely as an example that the central body is connected via struts 31, 32 to the thrust nozzle wall. For the provision of a bypass channel 4, the manner in which the central body 5 is arranged in the flow channel is basically not of importance. Alternatively, the central body 5 may for example be fastened to a nozzle needle arranged on the machine axis.

Furthermore, it is pointed out that the features of the individual described exemplary embodiments of the invention may be combined with one another in various combinations. If ranges are defined, said ranges thus comprise all of the values within said ranges as well as all of the partial ranges that lie in a range.

1. A thrust nozzle for a turbofan engine of a supersonic aircraft, wherein the thrust nozzle has:
a thrust nozzle wall,
a flow channel which is delimited radially to the outside by the thrust nozzle wall, wherein the flow channel has a nozzle throat area, and
a central body arranged in the flow channel,
wherein the central body forms a bypass channel which extends within the central body and which is provided for being flowed through by gas of the flow channel, wherein the bypass channel has at least one upstream inlet opening which is arranged upstream of the nozzle throat area of the flow channel and has at least one downstream outlet opening which is arranged downstream of the nozzle throat area of the flow channel.

2. The thrust nozzle as claimed in claim 1, wherein the central body is connected via at least one strut to the thrust nozzle wall.

3. The thrust nozzle as claimed in claim 2, wherein the central body, is connected via two struts to the thrust nozzle wall, which struts each have a profile with a leading edge and a trailing edge, wherein the two struts are arranged approximately in a plane.

4. The thrust nozzle as claimed in claim 2, wherein at least one upstream inlet opening of the bypass channel is formed in a strut, wherein the bypass channel, in a first upstream portion, runs in the strut and, in a second downstream portion, runs in the central body.

5. The thrust nozzle as claimed in claim 1, wherein the opening cross section of the bypass channel is settable.

6. The thrust nozzle as claimed in claim 5, wherein the opening cross section of the bypass channel is settable in continuous fashion by means of at least one actuator by means of which a cross-sectional area of the bypass channel is settable.

7. The thrust nozzle as claimed in claim 6, wherein the cross-sectional area of at least one inlet opening of the bypass channel is settable.

8. The thrust nozzle as claimed in claim 5, wherein the cross-sectional area of at least one outlet opening of the bypass channel is settable.

9. The thrust nozzle as claimed in claim 5, wherein the at least one actuator is arranged in or radially outside the thrust nozzle wall, which delimits the flow channels radially to the outside.

10. The thrust nozzle as claimed in claim 5, wherein the opening cross section of the bypass channel is settable by means of a closure body which is movable in an axial direction in the bypass channel and the axial position of which defines the opening cross section of the bypass channel.

11. The thrust nozzle as claimed in claim 10, wherein the closure body which is movable in the axial direction is displaceable in the axial direction relative to an upstream inlet opening or relative to a downstream outlet opening of the central body, wherein the closure body has a droplet shape.

12. The thrust nozzle as claimed in claim 5, wherein the opening cross section of the bypass channel is settable by means of exchangeable trim inserts with a defined cross-sectional area, which are insertable into the bypass channel at the start or at the end thereof.

13. The thrust nozzle as claimed in claim 1, wherein the thrust nozzle wall is designed to be non-adjustable with regard to the nozzle throat area and the nozzle exit area.

14. The thrust nozzle as claimed in claim 1, wherein the central body is of conical shape at its upstream end and/or at its downstream end and forms at least one maximum of its cross-sectional area between the upstream endue and the downstream end.

15. The thrust nozzle as claimed in claim 1, wherein the thrust nozzle is formed as a three-dimensional thrust nozzle with a rotationally symmetrical central body.

16. A turbofan engine for a supersonic aircraft, which has:
a fan, wherein the turbofan engine forms a primary flow channel and a secondary flow channel downstream of the fan,
a core engine, wherein the primary flow channel leads through the core engine and the secondary flow channel leads past the core engine,
a mixer, and
a thrust nozzle as claimed in claim 1, wherein the gas flow through the primary flow channel and the gas flow through the secondary flow channel are mixed by the mixer and fed to the flow channel of the thrust nozzle.

17. A method for setting the effective nozzle throat area of a thrust nozzle on a test stand, characterized by:
operating a turbofan engine having a thrust nozzle as claimed in claim 1 on a test stand;
setting that opening cross section of the bypass channel in the case of which the effective nozzle throat area arising from the sum of the opening cross section of the bypass channel and of the nozzle throat area corresponds to a desired value; and
fixing the set opening cross section of the bypass channel.

18. The method as claimed in claim 17, wherein the set opening cross section is fixed by means of at least one trim insert with a defined cross-sectional area, which is inserted into the bypass channel at the start or at the end thereof.

19. A method for setting the effective nozzle throat area of a thrust nozzle as claimed in claim 1 of a turbofan engine during the operation thereof, characterized by:
varying the opening cross section of the bypass channel in a manner dependent on the operating point of the engine, such that
the effective nozzle throat area arising from the sum of the opening cross section of the bypass channel and of the nozzle throat areal of the flow channel corresponds to a desired value in every operating state.

20. The method as claimed in claim 19, wherein the opening cross section of the bypass channel is set to a maximum upon starting.
